(19) United States
(12) Patent Application Publication
(10) Pub. No.: US 2021/0295135 A1
(43) Pub. Date: Sep. 23, 2021

(54) METHOD FOR IDENTIFYING P300 SIGNAL BASED ON MS-CNN, DEVICE AND STORAGE MEDIUM

(71) Applicant: Wuyi University, Jiangmen (CN)

(72) Inventors: Hongtao Wang, Jiangmen (CN); Zi'an Pei, Jiangmen (CN); Linfeng Xu, Jiangmen (CN)

(21) Appl. No.: 17/004,815

(22) Filed: Aug. 27, 2020

(30) Foreign Application Priority Data
Mar. 18, 2020 (CN) 2020101909676

(51) Int. Cl. G06N 3/04; G06N 3/08

(52) U.S. Cl. CPC G06N 3/0481; G06N 3/08

(57) ABSTRACT

Disclosed are a method for identifying P300 signal based on MS-CNN, device and storage medium, the method includes: collecting P300 signal; denoising the collected P300 signal; establishing MS-CNN network and setting network parameters thereof; receiving cross-subject data and performing feature extraction and classification to establish a cross-subject model via the MS-CNN network; receiving subject-specific data and establishing a subject-specific model via the MS-CNN network, based on a transfer learning technology and the cross-subject model.

### CROSS-REFERENCE TO RELATED APPLICATIONS

This application is based on and claims the benefit of priority from Chinese Patent Application No. 2020101909676, filed on 18 Mar. 2020, the entirety of which is incorporated by reference herein.

### TECHNICAL FIELD

The present disclosure relates to the field of signal identification, and in particular, to a method for identifying P300 signal based on MS-CNN, device and storage medium.

### BACKGROUND

BRAIN-Computer Interface (BCI) provide nonmusculoskeletal control and communication through directly converting brain activity into the informative signals for computers and/or external devices. Since the first proof-of-concept study demonstrating the feasibility of BCI in moving a graphical object on a computer screen using EEG, great efforts have been made to drive the technique to applicable implementations in real-life conditions, with the ultimate aim of improving daily life for users with motor disabilities. Among different BCI paradigms, event related potential (ERP)-based BCI is a non-invasive one that has been widely employed for its high reliability. In particular, P300, a decision making-related positive waveform at around 300 ms after receiving the stimulus (visual, auditory, tactile, etc.), has been repeatedly adopted for ERP-based BCI system development and demonstrated its feasibility in TV control, virtual keyboard design and BCI speller.

When establishing a P300 identification model, most researchers need to use a large amount of data for training to get a better model. In real life, the training data obtained are often small samples and are not suitable for these large sample models. The BCI system based on P300 has to be applied in practice, not only serving a few people, so the research of cross-subject model should be the most important.

### SUMMARY

The present disclosure aims to address at least one of the technical problems existing in the prior art. For this purpose, the present disclosure proposes a method for identifying P300 signal based on MS-CNN, which can better characterize general data than traditional manual feature extraction, without relying too much on training data.

The present disclosure also proposes a device for identifying P300 signal based on MS-CNN using the above-mentioned method for identifying P300 signal based on MS-CNN.

The present disclosure also proposes a storage medium executable by the device for identifying P300 signal based on MS-CNN using the above-mentioned method for identifying P300 signal based on MS-CNN.

According to a first aspect of the present disclosure, a method for identifying P300 signal based on MS-CNN is provided, which includes:

collecting P300 signal;

denoising the collected P300 signal;

establishing MS-CNN network and setting network parameters thereof;

receiving cross-subject data and performing feature extraction and classification to establish a cross-subject model via the MS-CNN network;

receiving subject-specific data and establishing a subject-specific model via the MS-CNN network, based on a transfer learning technology and the cross-subject model.

The method for identifying P300 signal based on MS-CNN according to an embodiment of the present disclosure has at least the following beneficial effects: in the process of identifying the P300 signal, firstly collect the P300 signal, and then perform denoising processing on the collected P300 signal to remove the interference signal in the P300 signal thus improve the signal-to-noise ratio of the signal; then build the MS-CNN network, the MS-CNN network is a multi-scale convolutional neural network which has a strong advantage in processing data, and when performing feature extraction, it directly acts on the original data and automatically performs feature learning layer by layer. Compared with the traditional manual feature extraction, it can better characterize the general data without relying too much on training data, using cross-subject data to build a universal cross-subject model, that is, a subject-unspecific model, where cross-subject model has higher generalization and robustness; and based on the established cross-subject model, combined with transfer learning technology, a subject-specific model can be obtained, so that target characters can be identified based on a small sample.

According to some embodiments of the present disclosure, wherein denoising the collected P300 signal includes:

band-pass filtering the collected P300 signal;

de-meaning the band-pass filtered P300 signal in a pre-processing;

superposition averaging the de-meant P300 signal in the pre-processing.

According to some embodiments of the present disclosure, wherein the MS-CNN network includes:

an input layer for loading data;

a first convolution layer composed of multiple convolution kernels, used to remove redundant space information and improve the signal-to-noise ratio of signal;

a second convolution layer composed of three convolution layers arranged in parallel, each convolution layer comprising a same number of convolution kernels, a size of each convolution kernel being inconsistent, used to extract features and increase a complexity of features;

a first connection layer for superimposing feature information obtained from the second convolution layer;

a maximum pooling layer used to reduce network parameters, speed up calculation, and prevent overfitting of a small number of training samples;

a third convolution layer used to perform convolution filtering on the features processed by the maximum pooling layer;

a second connection layer used to reshape the information processed by the third convolution layer into a vector.

According to some embodiments of the present disclosure, wherein a calculation formula of superposition averaging the de-meant P300 signal in the pre-processing can be expressed as:

$${x}_{i} ( t ) = \frac{1}{N} {\sum }_{i = 1}^{N} {s}_{i} ( t ) + \frac{1}{N} {\sum }_{i = 1}^{N} {n}_{i} ( t ) ;$$

wherein, xᵢ (t) is a detection signal, sᵢ (t) is a noise signal, nᵢ (t) is an original signal, and N is the number of times of superposition averaging.

According to some embodiments of the present disclosure, wherein a calculation formula used by the first convolution layer can be expressed as:

$${x}_{j}^{2} = f ( {\sum }_{i ∈ {M}_{j}} {I}_{i} \times {k}_{ij}^{2} + {b}_{j}^{2} ) ;$$

where Xⱼ² stands for the j^{th} feature map of the first convolution layer, f is the activation function, using the rectified linear unit, l stands for the input data, k is the convolution kernel matrix, and b is the additive bias, Mⱼ represents a selection of input maps.

According to some embodiments of the present disclosure, wherein calculation formulas for the second convolution layer using three different scale convolution kernels can be expressed as:

$${x}_{j}^{3 , 1} = f ( {\sum }_{i ∈ {M}_{j}} {x}_{i}^{2} \times {k}_{ij}^{3 , 1} + {b}_{j}^{3 , 1} ) ;$$

$${x}_{j}^{3 , 2} = f ( {\sum }_{i ∈ {M}_{j}} {x}_{i}^{2} \times {k}_{ij}^{3 , 2} + {b}_{j}^{3 , 2} ) ;$$

$${x}_{j}^{3 , 3} = f ( {\sum }_{i ∈ {M}_{j}} {x}_{i}^{2} \times {k}_{ij}^{3 , 3} + {b}_{j}^{3 , 3} ) ;$$

where, xⱼ^{3,1}, xⱼ^{3,2} and xⱼ^{3,3} stand for output maps of different convolution kernels in the second convolutional layer.

According to some embodiments of the present disclosure, wherein a calculation formula used by the third convolution layer can be expressed as:

$${x}_{j}^{6} = f ( {\sum }_{i ∈ {M}_{j}} {x}_{i}^{5} \times {k}_{ij}^{6} + {b}_{j}^{6} ) ;$$

where x⁵ represents the output passing through the maximum pooling layer, and x⁶ is the output of the third convolution layer.

According to a second aspect of the present disclosure, a device for identifying P300 signal based on MS-CNN is provided, which includes:

a collecting unit for collecting P300 signal;

a denoising unit for denoising the collected P300 signal;

a network establishing unit for establishing the MS-CNN network and setting network parameters thereof;

a processing identification unit configured to control the MS-CNN network to receive cross-subject data and perform feature extraction and classification to establish a cross-subject model, and control the MS-CNN network to receive subject-specific data and establish a subject-specific model, based on a transfer learning technology and the cross-subject model.

The device for identifying P300 signal based on MS-CNN according to an embodiment of the present disclosure has at least the following beneficial effects: through the method for identifying P300 signal based on MS-CNN mentioned above, can better characterize general data than traditional manual feature extraction, without relying too much on training data.

According to some embodiments of the present disclosure, the denoising unit comprising:

a filtering unit for performing band-pass filtering on the collected P300 signal;

a pre-processing unit for de-meaning the band-pass filtered P300 signal in a pre-processing;

a superimposing unit for superposition averaging the de-meant P300 signal in the pre-processing.

According to a third aspect of the present disclosure, a storage medium for identifying P300 signal based on MS-CNN is provided, which stores instructions executable by a device for identifying P300 signal based on MS-CNN, the device for identifying P300 signal based on MS-CNN can execute the instructions for causing the device to execute the method for identifying P300 signal based on MS-CNN according to the first aspect of the present disclosure.

The storage medium for identifying P300 signal based on MS-CNN according to an embodiment of the present disclosure has at least the following beneficial effects: through the method for identifying P300 signal based on MS-CNN mentioned above, can better characterize general data than traditional manual feature extraction, without relying too much on training data.

Additional aspects and advantages of the present disclosure will be given in part in the following description, and part of them will become apparent from the following description, or be learned through the practice of the present disclosure.

### BRIEF DESCRIPTION OF THE DRAWINGS

The above and/or additional aspects and advantages of the present disclosure will become apparent and easily understood from the description of the embodiments in conjunction with the following drawings, in which:

FIG. 1 is a flowchart of a method for identifying a P300 signal based on MS-CNN according to a first embodiment of the present disclosure;

FIG. 2 is a working flowchart of a denoising process in a method for identifying a P300 signal based on MS-CNN according to the first embodiment of the present disclosure;

FIG. 3 is a schematic diagram of an MS-CNN network structure in the method for identifying a P300 signal based on MS-CNN according to the first embodiment of the present disclosure;

FIG. 4 is an experimental data diagram of an information transmission rate of the method for identifying a P300 signal based on MS-CNN according to the first embodiment of the present disclosure;

FIG. 5 is a schematic structural diagram of a device for identifying P300 signal based on MS-CNN according to a second embodiment of the present disclosure.

### DETAILED DESCRIPTION

Hereinafter, embodiments of the present disclosure will be described in detail. Examples of the embodiments are shown in the accompanying drawings, wherein the same or similar reference numerals represent the same or similar elements or elements having the same or similar functions throughout. The embodiments described below with reference to the drawings are exemplary and are only used to explain the present disclosure, and should not be construed as limiting the present disclosure.

In the description of the present disclosure, unless explicitly defined otherwise, words such as setting and connection should be understood in a broad sense, and those skilled in the art can reasonably determine the specific meaning of the above words in the present disclosure by combining the specific content of the technical solution.

### First Embodiment

In this embodiment, to evoke the P300 potential, the stimulus interface consists of a matrix of 6×6 characters. All rows and columns of this matrix were successively and randomly flashed for 175 ms. Two out of twelve flashes of rows or columns contained the target character (i.e., the combination of one particular row and one particular column). The responses evoked by target infrequent stimulis are different from the non-target which do not contains the P300 characters.

For data collection, a Neusen W device is applied to measure scalp EEG signals. The EEG is recorded from 64 active Ag—AgCl electrodes according to the international 10-20 systems. The EEG is referenced to Cpz and the sampling rate is set at 250 Hz. The impedance is kept below 10 kΩ for all electrodes. For the consideration of transfer learning, 57 channels are selected for further processing, which keeps the same channels of the public datasets.

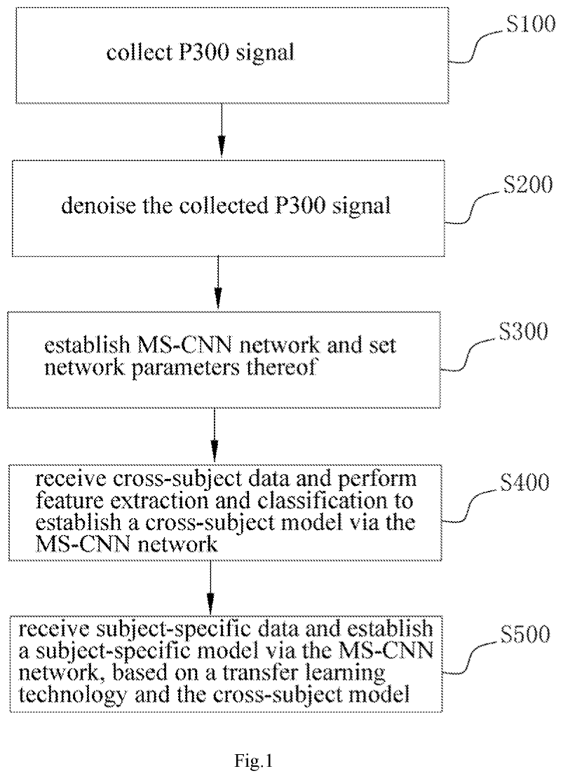

Referring to FIG. 1, a first embodiment of the present disclosure provides a method for identifying P300 signal based on MS-CNN. One embodiment includes, but is not limited to, the following steps:

In step S100, collecting P300 signal.

In this embodiment, the P300 signal is first collected in this step, and preliminary preparations are made for subsequent P300 signals. In this embodiment, electroencephalogram signals of a subject during P300 experiment can be collected using a wet electrode electroencephalogram acquisition device, where, the EEG data includes P300 and non-P300. In this embodiment, all the rows and columns will flash once in each experiment, and the row and column containing the target character will flash once each, for a total of two flashes. In this embodiment, target P300 is 1000 and non-target P300 (N-P300) is 5000. For neural network, the classification accuracy is highly dependent on the amount of training data. To address the unbalance issue, we extract the P300 under five number of repeats to augment the P300 sample. In this way, the datasets of P300 and N-P300 after the synthesis is equal, and the total number is up to 10000 (i.e., 5000 for P300 and N-P300 respectively). Thus, the problem of sample imbalance is well solved, and preparations are made for subsequent training of the MS-CNN neural network.

In step S200, denoising the collected P300 signal;

In this embodiment, this step performs denoising processing on the collected P300 signal, and removes interference signals in the P300 signal. For example, EEG signals are extremely vulnerable to signal interference (such as Electro-oculogram, ECG, EMG, and power frequency noise) during extraction, therefore, the collected original P300 signal needs to be removed to improve the signal-to-noise ratio of the signal, and for more accurate of subsequent identification.

In step S300, establishing MS-CNN network and setting network parameters thereof;

In this embodiment, in this step, an MS-CNN network is established, its network parameters are set, and multiple convolution kernels of different scales are used to extract features, and diversifying the information in different time periods, increasing the complexity of distinguishing features, while maintaining classification accuracy, the problem of low information transmission efficiency in the past model can be overcome. And the CNN network has a strong advantage in processing data, and when performing feature extraction, it directly acts on the original data and automatically performs feature learning layer by layer. Compared with the traditional manual feature extraction, it can better characterize the general data without relying too much on training data.

In step S400, receiving cross-subject data and performing feature extraction and classification to establish a cross-subject model via the MS-CNN network.

In this embodiment, in this step, transmitting the cross-subject data to the MS-CNN network, and then using the MS-CNN network to perform feature extraction and classification processing on the cross-subject data, and the identification result is converted into the corresponding target character, feedbacking the result, and the establishment of the cross-subject model is actually to use the public data set to establish a general subject-unspecific model, which is more generalized and robust.

In step S500, receiving subject-specific data and establishing a subject-specific model via the MS-CNN network, based on a transfer learning technology and the cross-subject model.

In this embodiment, in this step, using transfer learning technology and the above-mentioned obtained cross-subject model to establish a subject-specific model based on the obtained cross-subject model. Training a deep neural network requires a lot of annotated data, and in many scenarios, the amount of data is not enough to train a complete network. However, when the problem to be solved is similar to the problem already solved by the existing trained network, a small amount of annotated data could be used to achieve satisfactory accuracy. This is the principle of transfer learning. Heuristically, transfer learning could be used to adjust the existing trained network to the problems that need to be solved. A common practice is to first train a deep network on a large data set, then adjust the trained deep network, and finally apply the adjusted deep network to the actual requirements. Fine-tuning is normally used to adjust the parameters of the deep network. In this embodiment, the strategy of transfer learning is finetuning, which is based on the universal Ms-CNN model. The network structure and network parameters are retained and the output layer is fine-tuned using the subject-specific datasets. Specially, we initialize the parameters of the output layer in new random values. Running the back-propagation algorithm for 30,000 iterations, which optimizes the network parameters using adaptive moment estimation. By fine-tuning, the powerful generalization ability of deep neural networks can help for avoiding complex model design and time-consuming training. The established P300 identification model of a subject-specific can identify target characters based on a small sample and then provide feedback.

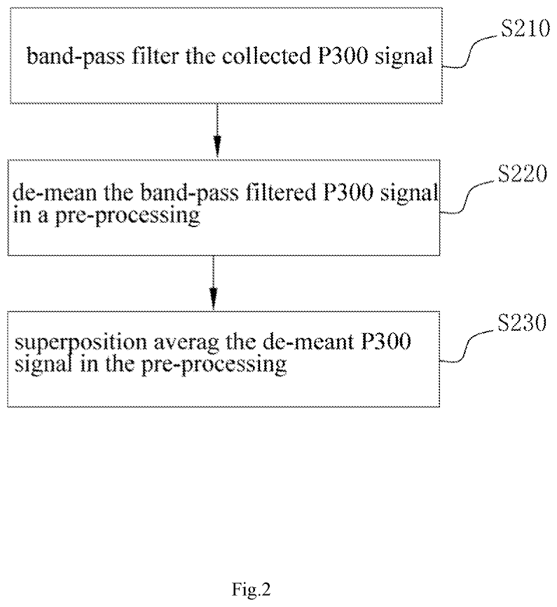

Referring to FIG. 2, step S200 in this embodiment may include, but is not limited to, the following steps:

In step S210, band-pass filtering the collected P300 signal.

In this embodiment, in this step, the collected P300 signal is processed by band-pass filtering to remove interference signals, improve the quality of EEG signals, and avoid the influence of power frequency interference.

In step S220, de-meaning the band-pass filtered P300 signal in a pre-processing;

In this embodiment, in this step, de-meaning the band-pass filtered P300 signal in a pre-processing, which also has the effect of removing interference signals and improving the accuracy of signal collection.

In step S230, superposition averaging the de-meant P300 signal in the pre-processing.

In this embodiment, in this step, superposition averaging the de-meant P300 signal in the pre-processing, thus, the signal-to-noise ratio of the P300 signal is improved, and being ready for subsequent MS-CNN network training identification and classification.

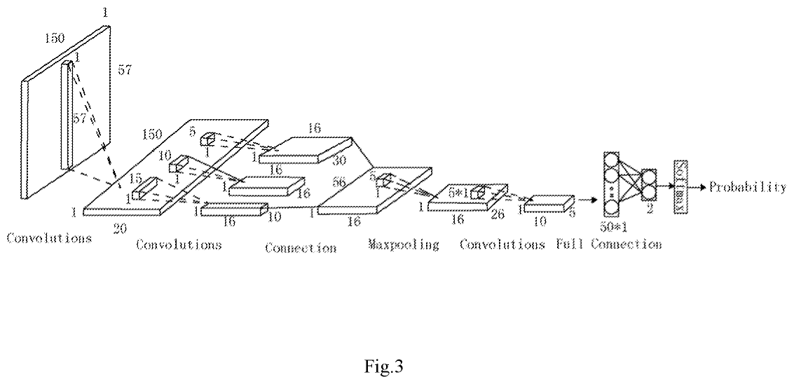

Referring to FIG. 3, the MS-CNN network in this embodiment includes: an input layer for loading P300 signal to be identified; a first convolution layer composed of multiple convolution kernels, used to remove redundant space information, similar to traditional signal statistical processing methods such as weighted superposition averaging and common space filtering, this method effectively improves the signal-to-noise ratio of the signal while removing redundant space information; a second convolution layer composed of three convolution layers arranged in parallel, each convolution layer comprising a same number of convolution kernels, a size of each convolution kernel being inconsistent, for a same input, convolution kernels of different scales extract different information, increasing the complexity of features, in this embodiment, the signals in the first convolution layer are temporally filtered on different time scales, and data features are extracted at different time periods to maximize the information; a first connection layer for superimposing the feature maps extracted from different filtering scales of the second convolution layer to fuse the extracted features; a maximum pooling layer, this pooling operation helps reduce the parameters of the network, thereby speeding up the calculation and preventing overfitting of a small number of training samples; a third convolution layer, which is a standard universal convolution layer, uses 10 convolution kernels of size 5, continues to perform convolution filtering operations on the features obtained from the maximum pooling layer to extract more abstract, deeper, and more useful features for classification, at the same time, this method reduces the network parameters of the last complete connection layer; a second connection layer used to reshape the information processed by the third convolution layer into a vector.

In this embodiment, superposition averaging the de-meant P300 signal in the pre-processing, wherein a calculation formula of superposition averaging the de-meant P300 signal in the pre-processing can be expressed as:

$${x}_{i} ( t ) = \frac{1}{N} {\sum }_{i = 1}^{N} {s}_{i} ( t ) + \frac{1}{N} {\sum }_{i = 1}^{N} {n}_{i} ( t ) ;$$

where, xᵢ(t) is a detection signal, sᵢ(t) is a noise signal, nᵢ(t) is an original signal, and N is the number of times of superposition averaging.

In this embodiment, a first convolution layer is composed of multiple convolution kernels and used to remove redundant space information and improve the signal-to-noise ratio of signal; a calculation formula used by the first convolution layer can be expressed as:

$${x}_{j}^{2} = f ( {\sum }_{i ∈ {M}_{j}} {I}_{i} \times {k}_{ij}^{2} + {b}_{j}^{2} ) ;$$

where Xⱼ² stands for the j^{th} feature map of the first convolution layer, f is the activation function, using the rectified linear unit, l stands for the input data, k is the convolution kernel matrix, and b is the additive bias, Mⱼ represents a selection of input maps.

In this embodiment, a second convolution layer is composed of three convolution layers arranged in parallel, each convolution layer comprising a same number of convolution kernels, a size of each convolution kernel being inconsistent, used to extract features and increase a complexity of features, wherein calculation formulas for the second convolution layer using three different scale convolution kernels can be expressed as:

$${x}_{j}^{3 , 1} = f ( {\sum }_{i ∈ {M}_{j}} {x}_{i}^{2} \times {k}_{ij}^{3 , 1} + {b}_{j}^{3 , 1} ) ;$$

$${x}_{j}^{3 , 2} = f ( {\sum }_{i ∈ {M}_{j}} {x}_{i}^{2} \times {k}_{ij}^{3 , 2} + {b}_{j}^{3 , 2} ) ;$$

$${x}_{j}^{3 , 3} = f ( {\sum }_{i ∈ {M}_{j}} {x}_{i}^{2} \times {k}_{ij}^{3 , 3} + {b}_{j}^{3 , 3} ) ;$$

where, xⱼ^{3,1}, xⱼ^{3,2} and xⱼ^{3,3} stand for output maps of different convolution kernels in the second convolutional layer.

In this embodiment, a third convolution layer is used to perform convolution filtering on the features processed by the maximum pooling layer, wherein a calculation formula used by the third convolution layer can be expressed as:

$${x}_{j}^{6} = f ( {\sum }_{i ∈ {M}_{j}} {x}_{i}^{5} \times {k}_{ij}^{6} + {b}_{j}^{6} ) ;$$

where x⁵ represents the output passing through the maximum pooling layer, and x⁶ is the output of the third convolution layer.

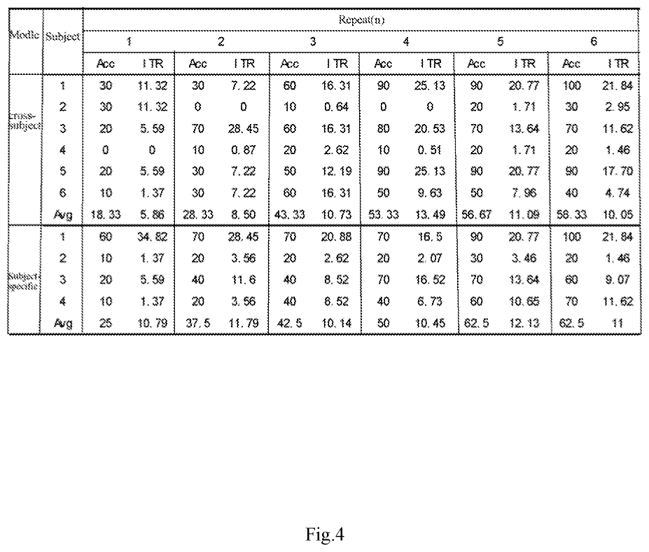

Referring to FIG. 4, in this embodiment, in order to quantitatively assess the effectiveness of the MS-CNN algorithm, it is necessary to measure the information transmission rate, which is ITR, and the following formula can be applied:

$$ITR = \frac{60}{T} [ {log}_{2} Q + P {log}_{2} P + ( 1 - P ) {log}_{2} ( \frac{1 - P}{Q - 1} ) ] ;$$

where Q stands for the number of target. P is the recognition accuracy of character. T means the time it takes for the character recognition, which is influenced by the number of repeat directly.

wherein the information obtained by the third convolution layer is reshaped into a vector x at the second connection layer, the output value h_{w,b}(x) of neuron can be expressed as:

h_{w,b}(x)=f(w^{T}x+b);

where w^{T} stand for weight vector. The output for each row and column is obtained by the softmax function in the form of a probability. In each round of repeat, all the rows and columns flicker only once and two out of these twelve flashes contain P300. More precisely, unique row and unique column should contain P300, otherwise it would be a wrong prediction of the target character. The decision strategy in the present work is to find the maximum probability of P300 form rows and columns respectively, which is provided in the following equation.

r=arg max Pᵣ(m)(1≤m≤6)

c=arg max P_{c}(m)(7≤m≤12)

where r and c stand for row and column. Pᵣ and P_{c} stand for the probability of P300 form rows and columns, m represents the number of the row and column. Once the row and column contained P300 are determined, the target character can be predicted correctly.

where, in this embodiment, the cross-entropy loss function is used to measure the classification error of the network. The regularization method is used for the first convolution layer to reduce the risk of over fitting, and the coefficient is set to 0.04. Training weight values with gradient descent optimizer the initial learning rate is 0.01, the attenuation rate is 0.9995, and the maximum number of iterations is 30000.

According to the above technical solution, in the process of identifying the P300 signal, firstly collect the P300 signal, and then perform denoising processing on the collected P300 signal to remove the interference signal in the P300 signal, thus improve the signal-to-noise ratio of the signal; then build the MS-CNN network, the MS-CNN network is a multi-scale convolutional neural network which has a strong advantage in processing data, and when performing feature extraction, it directly acts on the original data and automatically performs feature learning layer by layer. Compared with the traditional manual feature extraction, it can better characterize the general data without relying too much on training data, using cross-subject data to build a universal cross-subject model, that is, a subject-unspecific model, where cross-subject model has higher generalization and robustness; and based on the established cross-subject model, combined with transfer learning technology, a subject-specific model can be obtained, so that target characters can be identified based on a small sample.

### Second Embodiment

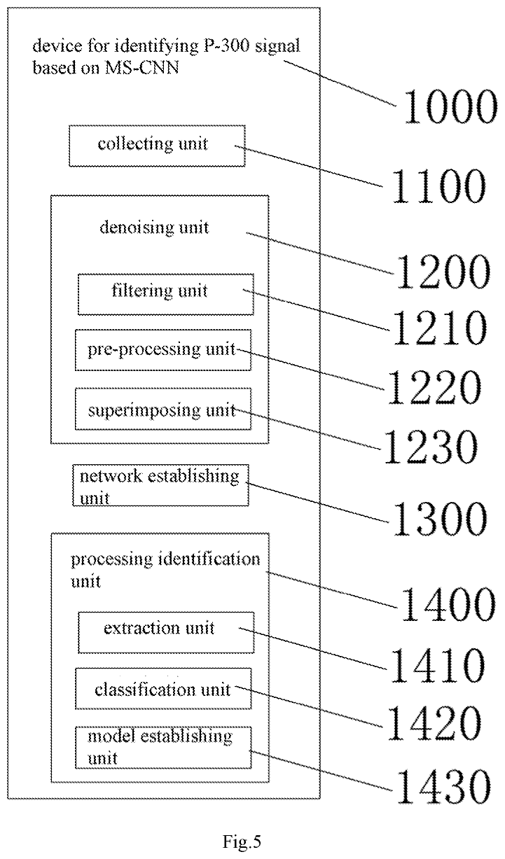

Referring to FIG. 5, a second embodiment of the present disclosure provides a device 1000 for identifying P300 signal based on MS-CNN, comprising:

a collecting unit 1100 for collecting P300 signal;

a denoising unit 1200 for denoising the collected P300 signal;

a network establishing unit 1300 for establishing the MS-CNN network and setting network parameters thereof;

a processing identification unit 1400 configured to control the MS-CNN network to receive cross-subject data and perform feature extraction and classification to establish a cross-subject model, and control the MS-CNN network to receive subject-specific data and establish a subject-specific model, based on a transfer learning technology and the cross-subject model.

It should be noted, since the device for identifying P300 signal based on MS-CNN in this embodiment is based on the same inventive concept as the a method for identifying P300 signal based on MS-CNN in the first embodiment. Therefore, the corresponding contents in the first method embodiment are also applicable to the device embodiment, which are not described in detail here.

In this embodiment, the denoising unit 1200 includes:

a filtering unit 1210 for performing band-pass filtering on the collected P300 signal;

a pre-processing unit 1220 for de-meaning the band-pass filtered P300 signal in a pre-processing;

a superimposing unit 1230 for superposition averaging the de-meant P300 signal in the pre-processing.

In this embodiment, the processing identification unit 1400 includes:

an extraction unit 1410, configured to perform feature extraction processing on the received data;

a classification unit 1420, configured to perform classification processing on the data after feature extraction;

a model establishing unit 1430, configured to establish a model according to a classification result. In this embodiment, not only a cross-subject model but also a subject-specific model needs to be established.

It can be known from the above solution that the collecting unit 1100 collects the P300 signal, the denoising unit 1200 performs denoising processing on the collected P300 signals to remove interference signals, then the MS-CNN network is established by the network establishing unit 1300, the data is then transmitted to the processing identification unit 1400 for feature extraction, then perform classifying, establishing a cross-subject model and a subject-specific model, finally identifying the target character and providing feedback. Compared with the traditional manual feature extraction, it can better characterize the general data without relying too much on training data.

### Third Embodiment

The third embodiment of the present disclosure also provides a storage medium for identifying P300 signal based on MS-CNN, the storage medium for identifying P300 signal based on MS-CNN stores instructions executable by the device for identifying P300 signal based on MS-CNN, the instructions executable by the device for identifying P300 signal based on MS-CNN are executed by one or more control processors, so that the one or more control processors can execute the method for identifying P300 signal based on MS-CNN in the first embodiment. For example, the method steps S100 to S500 in FIG. 1 described above are executed to implement the functions of the units 1100-1400 in FIG. 5.

In the description of this specification, the descriptions of the terms “one embodiment”, “some embodiments”, “exemplary embodiments”, “examples”, “specific examples”, or “some examples” and the like mean in connection with specific features, structures, materials or characteristics described in the embodiments or examples are included in at least one embodiment or example of the present disclosure. In this specification, the schematic expressions of the above terms do not necessarily refer to the same embodiment or example. Moreover, the specific features, structures, materials, or characteristics described may be combined in any suitable manner in any one or more embodiments or examples.

Although embodiments of the present disclosure have been shown and described, those skilled in the art can understand that various changes, modifications, substitutions, and alterations can be made to these embodiments without departing from the principle and concept of the present disclosure, and the scope of the present disclosure is defined by the claims and their equivalents.

We claim:

1. A method for identifying P300 signal based on MS-CNN, comprising:
collecting P300 signal;
denoising the collected P300 signal;
establishing MS-CNN network and setting network parameters thereof;
receiving cross-subject data and performing feature extraction and classification to establish a cross-subject model via the MS-CNN network;
receiving subject-specific data and establishing a subject-specific model via the MS-CNN network, based on a transfer learning technology and the cross-subject model.

2. The method of claim 1, wherein, denoising the collected P300 signal comprising:
band-pass filtering the collected P300 signal;
de-meaning the band-pass filtered P300 signal in a pre-processing;
superposition averaging the de-meant P300 signal in the pre-processing.

3. The method of claim 1, wherein the MS-CNN network comprises:
an input layer for loading data;
a first convolution layer composed of multiple convolution kernels, used to remove redundant space information and improve the signal-to-noise ratio of signal;
a second convolution layer composed of three convolution layers arranged in parallel, each convolution layer comprising a same number of convolution kernels, a size of each convolution kernel being inconsistent, used to extract features and increase a complexity of features;
a first connection layer for superimposing feature information obtained from the second convolution layer;
a maximum pooling layer used to reduce network parameters, speed up calculation, and prevent overfitting of a small number of training samples;
a third convolution layer used to perform convolution filtering on the features processed by the maximum pooling layer;
a second connection layer used to reshape the information processed by the third convolution layer into a vector.

4. The method of claim 2, wherein a calculation formula of superposition averaging the de-meant P300 signal in the pre-processing is expressed as:
$${x}_{i} ( t ) = \frac{1}{N} {\sum }_{i = 1}^{N} {s}_{i} ( t ) + \frac{1}{N} {\sum }_{i = 1}^{N} {n}_{i} ( t ) ;$$
wherein, xᵢ (t) is a detection signal, sᵢ (t) is a noise signal, nᵢ (t) is an original signal, and N is the number of times of superposition averaging.

5. The method of claim 3, wherein, a calculation formula used by the first convolution layer is expressed as:
$${x}_{j}^{2} = f ( {\sum }_{i ∈ {M}_{j}} {I}_{i} \times {k}_{ij}^{2} + {b}_{j}^{2} ) ;$$
where Xⱼ² stands for the j^{th} feature map of the first convolution layer, f is the activation function, using the rectified linear unit, l stands for the input data, k is the convolution kernel matrix, and b is the additive bias, Mⱼ represents a selection of input maps.

6. The method of claim 5, wherein calculation formulas for the second convolution layer using three different scale convolution kernels are expressed as:
$${x}_{j}^{3 , 1} = f ( {\sum }_{i ∈ {M}_{j}} {x}_{i}^{2} \times {k}_{ij}^{3 , 1} + {b}_{j}^{3 , 1} ) ;$$
$${x}_{j}^{3 , 2} = f ( {\sum }_{i ∈ {M}_{j}} {x}_{i}^{2} \times {k}_{ij}^{3 , 2} + {b}_{j}^{3 , 2} ) ;$$
$${x}_{j}^{3 , 3} = f ( {\sum }_{i ∈ {M}_{j}} {x}_{i}^{2} \times {k}_{ij}^{3 , 3} + {b}_{j}^{3 , 3} ) ;$$
where, xⱼ^{3,1}, xⱼ^{3,2} and xⱼ^{3,3} stand for output maps of different convolution kernels in the second convolutional layer.

7. The method of claim 6, wherein a calculation formula used by the third convolution layer is expressed as:
$${x}_{j}^{6} = f ( {\sum }_{i ∈ {M}_{j}} {x}_{i}^{5} \times {k}_{ij}^{6} + {b}_{j}^{6} ) ;$$
where x⁵ represents the output passing through the maximum pooling layer, and x⁶ is the output of the third convolution layer.

8. A device for identifying P300 signal based on MS-CNN, comprising:
a collecting unit for collecting P300 signal;
a denoising unit for denoising the collected P300 signal;
a network establishing unit for establishing the MS-CNN network and setting network parameters thereof;
a processing identification unit configured to control the MS-CNN network to receive cross-subject data and perform feature extraction and classification to establish a cross-subject model, and control the MS-CNN network to receive subject-specific data and establish a subject-specific model, based on a transfer learning technology and the cross-subject model.

9. The device of claim 8, wherein the denoising unit comprising:
a filtering unit for performing band-pass filtering on the collected P300 signal;
a pre-processing unit for de-meaning the band-pass filtered P300 signal in a pre-processing;
a superimposing unit for superposition averaging the de-meant P300 signal in the pre-processing.

10. A storage medium for identifying P300 signal based on MS-CNN, wherein the storage medium for identifying P300 signal based on MS-CNN stores instructions executable by a device for identifying P300 signal based on MS-CNN, the instructions are executable by the device for identifying P300 signal based on MS-CNN to cause the device to execute steps of:
collecting P300 signal;
denoising the collected P300 signal;
establishing MS-CNN network and setting network parameters thereof;
receiving cross-subject data and performing feature extraction and classification to establish a cross-subject model via the MS-CNN network;
receiving subject-specific data and establishing a subject-specific model via the MS-CNN network, based on a transfer learning technology and the cross-subject model.

11. The storage medium of claim 10, wherein, denoising the collected P300 signal comprising:
band-pass filtering the collected P300 signal;
de-meaning the band-pass filtered P300 signal in a pre-processing;
superposition averaging the de-meant P300 signal in the pre-processing.

12. The storage medium of claim 10, wherein the MS-CNN network comprises:
an input layer for loading data;
a first convolution layer composed of multiple convolution kernels, used to remove redundant space information and improve the signal-to-noise ratio of signal;
a second convolution layer composed of three convolution layers arranged in parallel, each convolution layer comprising a same number of convolution kernels, a size of each convolution kernel being inconsistent, used to extract features and increase a complexity of features;
a first connection layer for superimposing feature information obtained from the second convolution layer;
a maximum pooling layer used to reduce network parameters, speed up calculation, and prevent overfitting of a small number of training samples;
a third convolution layer used to perform convolution filtering on the features processed by the maximum pooling layer;
a second connection layer used to reshape the information processed by the third convolution layer into a vector.

13. The storage medium of claim 11, wherein a calculation formula of superposition averaging the de-meant P300 signal in the pre-processing is expressed as:
$${x}_{i} ( t ) = \frac{1}{N} {\sum }_{i = 1}^{N} {s}_{i} ( t ) + \frac{1}{N} {\sum }_{i = 1}^{N} {n}_{i} ( t ) ;$$
wherein, xᵢ (t) is a detection signal, sᵢ (t) is a noise signal, nᵢ (t) is an original signal, and N is the number of times of superposition averaging.

14. The storage medium of claim 12, wherein, a calculation formula used by the first convolution layer is expressed as:
$${x}_{j}^{2} = f ( {\sum }_{i ∈ {M}_{j}} {I}_{i} \times {k}_{ij}^{2} + {b}_{j}^{2} ) ;$$
where Xⱼ² stands for the j^{th} feature map of the first convolution layer, f is the activation function, using the rectified linear unit, l stands for the input data, k is the convolution kernel matrix, and b is the additive bias, Mⱼ represents a selection of input maps.

15. The storage medium of claim 14, wherein calculation formulas for the second convolution layer using three different scale convolution kernels are expressed as:
$${x}_{j}^{3 , 1} = f ( {\sum }_{i ∈ {M}_{j}} {x}_{i}^{2} \times {k}_{ij}^{3 , 1} + {b}_{j}^{3 , 1} ) ;$$
$${x}_{j}^{3 , 2} = f ( {\sum }_{i ∈ {M}_{j}} {x}_{i}^{2} \times {k}_{ij}^{3 , 2} + {b}_{j}^{3 , 2} ) ;$$
$${x}_{j}^{3 , 3} = f ( {\sum }_{i ∈ {M}_{j}} {x}_{i}^{2} \times {k}_{ij}^{3 , 3} + {b}_{j}^{3 , 3} ) ;$$
where, xⱼ^{3,1}, xⱼ^{3,2} and xⱼ^{3,3} stand for output maps of different convolution kernels in the second convolutional layer.

16. The storage medium of claim 15, wherein a calculation formula used by the third convolution layer is expressed as:
$${x}_{j}^{6} = f ( {\sum }_{i ∈ {M}_{j}} {x}_{i}^{5} \times {k}_{ij}^{6} + {b}_{j}^{6} ) ;$$
where x⁵ represents the output passing through the maximum pooling layer, and x⁶ is the output of the third convolution layer.
